(19) United States
(12) Patent Application Publication
(10) Pub. No.: US 2005/0214647 A1
(43) Pub. Date: Sep. 29, 2005

(54) Electrode manufacturing method, electrode, electrochemical device manufacturing method and electrochemical device

(75) Inventors: Hideki Tanaka, Tokyo (JP); Kazuo Katai, Tokyo (JP); Yousuke Miyaki, Tokyo (JP); Kiyonori Hinoki, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/089,009

(22) Filed: Mar. 24, 2005

(30) Foreign Application Priority Data
Mar. 24, 2004 (JP) P2004-087539

(51) Int. Cl. H01M 4/64; H01M 4/04

(52) U.S. Cl. 429/233; 29/623.1

(57) ABSTRACT

The present invention is an electrode manufacturing method comprising a cutting step wherein an electrode sheet formed by an active substance-containing layer on a charge collector is cut to obtain an electrode element which is part of the electrode sheet, and a heating/pressurizing step which gives heating/pressurizing treatment to at least the edge part of the active substance-containing layer in the electrode element.

### BACKGROUND OF THE INVENTION

1. Field of the Invention

The present invention relates to a method of manufacturing an electrode which can be used for electrochemical devices, such as a primary battery, secondary battery (in particular a lithium ion secondary battery), an electrolysis cell, and a capacitor (in particular an electrochemical capacitor), an electrode, a method of manufacturing an electrochemical device, and an electrochemical device.

2. Background Art

Electrochemical capacitors including electrical double layer capacitors, and non-aqueous electrolyte secondary batteries including lithium ion secondary batteries, are electrochemical devices which can be easily made compact and lightweight, so they are expected as as backup power supplies for portable devices (small electronic devices), or auxiliary power supplies for electric vehicles or hybrid vehicles. Various studies aimed at improving their performance have been carried out.

The electrode used for these electrochemical devices is manufactured by forming an active substance-containing layer containing an electrode active substance on a charge collector. The component materials and method of manufacturing this electrode vary depending on the type of electrochemical device, but in the case of an electrical double layer capacitor, component materials of the active substance-containing layer such as an electrode active substance such as active carbon, a conductive auxiliary agent and binder are kneaded in a dispersion medium, and an electrode sheet is formed by applying this to a charge collector surface as a coating. The obtained electrode sheet is then cut to a predetermined size to obtain the electrode (for example, JP-A 2003-309046).

Another method generally used is to fashion the active substance-containing layer into a sheet beforehand, and stick this onto the charge collector to form an electrode sheet. In this case, for example, the component materials of the aforesaid active substance-containing layer are kneaded, and after rolling this into a sheet with a roller, an electrode sheet is formed by sticking this sheet to a charge collector via an electrically conducting adhesive. The obtained electrode sheet is then cut to a predetermined size to manufacture the electrode (for example, JP-A 2003-309046).

In these electrode manufacturing methods, since the electrode sheet wherein the active substance-containing layer is formed on the charge collector, can be formed beforehand and electrodes of predetermined size can be continuously cut from this electrode sheet, it is possible to manufacture the electrodes efficiently.

### SUMMARY OF THE INVENTION

However when the electrode sheet, comprising the active substance-containing layer formed on the charge collector as mentioned above, was cut to a predetermined size to manufacture the electrode, chipping and peeling tended to occur in the cut part of the active substance-containing layer due to the shearing stress produced when the active substance-containing layer was cut. Once chipping and peeling occurs in the active substance-containing layer, a good electron conduction path can no longer be established in the active substance-containing layer, and the electron conductivity tends to fall. In the manufacture of an electrochemical device, the device is subject to mechanical stress mainly when the edge part of the active substance-containing layer comes in contact with other components, and chipping and peeling of the active substance-containing layer become worse starting at the edge part. In some cases, the active substance-containing layer dropped out altogether, and caused a short circuit between the electrodes.

It is therefore an object of the invention to provide a method of manufacturing an electrode wherein chipping and peelin of the active substance-containing layer are adequately prevented, and chipping and peeling of the active substance-containing layer during manufacture of an electrochemical device are adequately suppressed, to provide an electrode, to provide an electrochemical device using this electrode, and to provide a method of manufacturing same.

As a result of intensive research intended to attain the above object, the Inventors found that, after cutting the electrode sheet to obtain an electrode element, the above object could be attained by giving heating/pressurizing treatment to at least the edge part of the active substance-containing layer in this electrode element, and thereby arrived at the present invention.

Namely, the method of manufacturing an electrode according to the present invention comprises a cutting step wherein an electrode sheet having an active substance-containing layer formed on a charge collector is cut to obtain an electrode element which is a part of the electrode sheet, and a heating/pressurizing treatment step wherein at least the edge part of the active substance-containing layer in the electrode element is subjected to heating/pressurizing treatment.

Here, in the above electrode, the active substance-containing layer may be formed on only one surface of the charge collector, or the active substance-containing layer may be formed on both surfaces of the charge collector. When the active substance-containing layer is formed on both surfaces, it is sufficient to give heating/pressurizing treatment to at least one of the active substance-containing layers (if chipping and peeling occur in one of the layers, this is the layer that should be treated). However, in order to more adequately prevent chipping and peeling of the active substance-containing layer during manufacture of the electrochemical device, it is preferred to give heating/pressurizing treatment to both active substance-containing layers.

When an electrode sheet is cut to a predetermined size by manufacturing an electrode by the above manufacturing method, even if chipping and peeling occur in the cut part of the active substance-containing layer, by giving heating/pressurizing treatment to at least the edge part of the active substance-containing layer, the peelings re-adhere and the layer is restored. Hence, an electrode can be obtained wherein chipping and peeling of the active substance-containing layer is adequately suppressed. Also, when manufacturing an electrode by the above manufacturing method, the density of the edge part of the active substance-containing layer can be improved by the above heating/pressurizing treatment, and the mechanical strength of this edge part can be considerably improved. Hence, in the electrode obtained, chipping and peeling of the active substance-containing layer during manufacture of an electrochemical device can be adequately suppressed.

In the above heating/pressuring process, it is preferred to give heating/pressurizing treatment to the edge part of the active substance-containing layer and to the center part surrounded by the edge part.

If this is done, the above effect is more adequate, the density of the whole active substance-containing layer is much improved, and the volumetric capacity is improved.

In the heating/pressurizing treatment, it is preferred to perform the heating/pressurizing treatment so that the minimum film thickness of the edge part of the active substance-containing layer is less than the maximum film thickness of the center part, and it is more preferred that, if the decreased film thickness of the edge part of the active substance-containing layer is D1 and the maximum film thickness of the center part is D2, the value of (D1/D2) satisfies the following relation:
0.01≦(D1/D2)≦0.4

By performing the heating/pressurizing treatment so that the film thickness of the edge part of the active substance-containing layer and the film thickness of the center part have the aforesaid relation, the edge part of the active substance-containing layer is amply compressed, and even if chipping and peeling occur in the active substance-containing layer when the electrode sheet is cut, this chipping and peeling can be more adequately restored. Since the mechanical strength of the edge part of the active substance-containing layer can be more adequately improved in the obtained electrode, chipping and peeling of the active substance-containing layer can be more adequately suppressed in the manufacture of the electrochemical device. In addition to the above effect, sufficient volumetric capacity can also be obtained.

Here, when the value of (D1/D2) is less than 0.01, as compared with the case when the value of (D1/D2) is within the above range, the restoration of chipping and peeling of the active substance-containing layer, and the improvement of mechanical strength of the edge part of the active substance-containing layer, tend to be insufficient. On the other hand, if the value of (D1/D2) exceeds 0.4, as compared with the case where the value of (D1/D2) is within the above range, the edge part of the active substance-containing layer is compressed too much, and when an electrochemical device is formed, the electrolytic solution does not easily permeate the active substance-containing layer, the size of the double layer interface decrease, and it tends to be difficult to obtain sufficient volumetric capacity.

In the manufacturing method of the present invention, it is preferred to perform heating/pressurizing treatment so that the film thickness of the edge part of the active substance-containing layer and the film thickness of the center part have the aforesaid relation, and so that the edge part of the active substance-containing layer is tapered toward the outside of the center part (hereafter, referred to as “tapered shape”).

In general, in an electrode, if a right angle or an acute angle is present in the edge part of the active substance-containing layer, in the manufacture of the electrochemical device, the above angle easily comes in contact with other components, stress is concentrated in the above angle, and chipping and peeling of the active substance-containing layer tend to occur with this angle as the starting point. On the other hand, due to the above manufacturing method, the edge part is compressed to form a tapered shape as mentioned above, so right angles or acute angles in the edge part of the active substance-containing layer are eliminated, and chipping and peeling of the active substance-containing layer in the manufacture of the electrochemical device can be more adequately suppressed.

In the above heating/pressurizing treatment step, it is preferred that the solvent content in the active substance-containing layer is 20 mass % or less.

When the solvent content exceeds 20 mass %, as compared with the case where the solvent content is 20 mass % or less, when heating/pressurizing treatment is performed using a heat press, the surface of the active substance-containing layer tends to adhere to the heat press, and chipping and peeling of the active substance-containing layer tend to occur.

In the manufacturing method of the present invention, it is preferred to perform the heating/pressurizing treatment at a temperature of 100-250° C.

If the temperature in the heating/pressurizing treatment is less than 100° C., as compared with the case where the temperature is within the above range, it tends to be difficult to adequately restore the chipping and peeling of the active substance-containing layer, and if the temperature exceeds 250° C., as compared with the case where the temperature is within the above range, the binder in the active substance-containing layer tends to decompose, and the mechanical strength of the active substance-containing layer easily tends to fall.

In the manufacturing method of the present invention, it is preferred to perform the heating/pressurizing treatment at a pressure of 0.098 MPa or more.

If the pressure during heat/pressure treatment is less than 0.098 MPa, as compared with the case where the pressure is 0.098 MPa or more, it tends to be difficult to adequately restore the chipping and peeling of the active substance-containing layer.

In the manufacturing method of the present invention, it is preferred to perform the heating/pressurizing treatment using a heat press.

By using a heat press, the above heating/pressurizing treatment is simple to perform.

Here, the heat press is not particularly limited provided that at least the edge part of the active substance-containing layer, or the edge part and the center part, can be subjected to a heating/pressurizing treatment. However, it is preferred to use a heat press which can perform heating/pressurizing treatment so that the film thickness relation between the edge part and the center part of the active substance-containing layer mentioned above, is satisfied, and more preferred to use a heat press which can perform heat/pressure treatment so that the shape of the edge part is the aforesaid tapered shape. In this way, the effect of the present invention can be more adequately obtained.

The present invention also provides an electrode comprising a charge collector and an active substance-containing layer formed on this charge collector, wherein the active substance-containing layer has a center part and an edge part surrounding this center part, heating/pressurizing treatment of at least the edge part is performed, and the minimum film thickness of the edge part is less than the maximum film thickness of the center part of the active substance-containing layer.

In an electrode having this configuration, the mechanical strength of the edge part of the active substance-containing layer is much improved, and chipping and peeling of the active substance-containing layer during manufacture of the electrochemical device can be adequately suppressed.

Also, in the electrode of the present invention, it is preferred that in the above active substance-containing layer, both the center part and the edge part of this active substance-containing layer are given heating/pressurizing treatment.

If this is done, the above effect is more adequately obtained, the density of the whole active substance-containing layer can be substantially improved, and superior volumetric capacity can be obtained.

In the present invention, it is preferred that, if the decreased film thickness of the edge part of the active substance-containing layer is D1, and the maximum film thickness of the center part is D2, the value of the ratio (D1/D2) satisfies the following relation:
0.01≦(D1/D2)≦0.4

Here, if the value of (D1/D2) is less than 0.01, as compared with the case where the value of (D1/D2) is within the above range, the mechanical strength of the edge part of the active substance-containing layer is insufficient, and it then becomes difficult to adequately obtain the suppression effect of chipping and peeling of the active substance-containing layer during manufacture of the electrochemical device. On the other hand, if the value of (D1/D2) exceeds 0.4, as compared with the case where the value of (D1/D2) is within the above range, the edge part of the active substance-containing layer is compressed too much, and when the electrochemical device is formed, the electrolytic solution does not easily permeate the active substance-containing layer, the size of the double layer interface decreases, and it may be difficult to obtain sufficient volumetric capacity.

It is also preferred that, in the electrode of the present invention, the shape of the edge part of the active substance-containing layer is tapered toward the outside of the center part (tapered shape).

Hence, by compressing the edge part to form a tapered shape, right angles or acute angles in the edge part of the active substance-containing layer are eliminated, and chipping and peeling of the active substance-containing layer during manufacture of the electrochemical device can be more adequately suppressed.

The present invention further provides a method of manufacturing an electrochemical device comprising a first electrode and a second electrode arranged opposite to each other, a separator disposed between the first electrode and second electrode, an electrolyte arranged between the first electrode and second electrode, and a case housing the first electrode, second electrode, separator and electrolyte sealed inside, the method comprising a step wherein at least one of the first electrode and second electrode is manufactured by the electrode manufacturing method of the present invention described above.

According to this manufacturing method, since at least one of the first electric and second electrode is manufactured by the electrode manufacturing method of the invention described above, chipping and peeling of the active substance-containing layer can be adequately suppressed. Therefore, an electrochemical device wherein short circuits between electrodes are adequately suppressed, can be obtained.

In order to obtain the aforesaid effect more adequately, it is more preferred to manufacture both the first electrode and second electrode by the electrode manufacturing method of the invention described above.

The present invention further provides an electrochemical device comprising a first electrode and a second electrode arranged opposite to each other, a separator disposed between the first electrode and second electrode, an electrolyte arranged between the first electrode and second electrode, and a case housing the first electrode, second electrode, separator and electrolyte sealed inside, wherein at least one of the first electrode and second electrode is the electrode of the present invention described above.

Since this electrochemical device uses the electrode of the present invention described above as at least one of the first electrode and second electrode, chipping and peeling of the active substance-containing layer can be adequately suppressed, and short-circuits between the electrodes can be adequately suppressed.

In order to obtain the aforesaid effect more adequately, it is more preferred that both the first electrode and second electrode are the electrode of the present invention described above.

### BRIEF DESCRIPTION OF THE DRAWINGS

FIG. 1 is a schematic cross-sectional view showing a preferred embodiment of an electrode according to the present invention.

FIG. 2 is a view illustrating a step for preparing an electrode-forming coating solution.

FIG. 3 is a view illustrating a step for forming an electrode sheet using the electrode-forming coating solution.

FIG. 4 is a view illustrating a step for forming the electrode sheet using the electrode-forming coating solution.

FIG. 5 is a view illustrating a sequence of steps for forming an electrode from the electrode sheet.

FIG. 6 is a view illustrating a sequence of steps for giving heating/pressurizing treatment to the electrode.

FIG. 7 is a view illustrating a sequence of steps for giving heating/pressurizing treatment to the electrode.

FIG. 8 is a view illustrating a step for giving heating/pressurizing treatment to the electrode to the electrode.

FIG. 9 is view illustrating a sequence of steps for giving heating/pressurizing treatment to the electrode.

FIG. 10 is a view illustrating a sequence of steps for giving heating/pressurizing treatment to the electrode.

FIG. 11 shows an electron micrograph (magnification: 250×) of a side face (cut surface) of an electrode element 130 shown in FIG. 10.

FIG. 12 shows an electron micrograph (magnification: 250×) of a side face (cut surface) of an electrode 30 shown in FIG. 10.

FIG. 13 is a front view showing a preferred embodiment (electrical double layer capacitor) of an electrochemical device according to the present invention.

FIG. 14 is a cut-away view of the interior of the electrochemical device 1 shown in FIG. 13 seen from the normal direction of the surface of an anode 10.

FIG. 15 is a schematic cross-sectional view when an electrochemical device 1 shown in FIG. 13 is cut along a line X1-X1 in FIG. 13.

FIG. 16 is a schematic cross-sectional view showing essential parts when the electrochemical device 1 shown in FIG. 13 is cut along a line X2-X2 in FIG. 13.

FIG. 17 is a schematic cross-sectional view showing essential parts when the electrochemical device 1 shown in FIG. 13 is cut along a line Y-Y in FIG. 13.

FIG. 18 is a schematic cross-sectional view showing an example of the basic construction of a film which is a component material of a case of the electrochemical device 1 shown in FIG. 13.

FIG. 19 is a schematic cross-sectional view showing another example of the basic construction of a film which is a component material of the case of the electrochemical device 1 shown in FIG. 13.

FIG. 20 is a schematic cross-sectional view showing another embodiment of the electrochemical device of the present invention.

### DESCRIPTION OF THE PREFERRED EMBODIMENTS

Hereafter, a preferred embodiment of the present invention will be described in detail referring to the drawings. In the following description, identical or corresponding parts are assigned identical symbols, and their overlapping description will not be repeated.

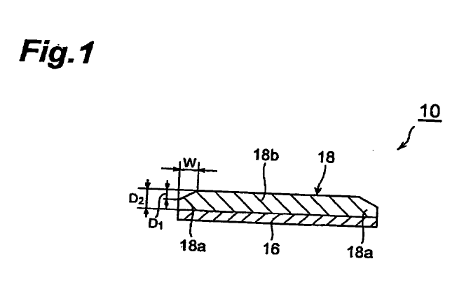

(Electrode, and electrode manufacturing method) FIG. 1 is a schematic cross-sectional view showing one embodiment of the electrode of the present invention.

As shown in FIG. 1, an electrode 10 is provided with a charge collector 16 having electron conductivity and an active substance-containing layer 18 having electron conductivity formed on this charge collector 16.

Here, the charge collector 16 is not particularly limited provided that it is a good conductor which can adequately transfer charge to the active substance-containing layer 18, and it may be a charge collector employed in electrodes of electrochemical devices known in the art. For example, the charge collectors 16 may be a metal foil of aluminum or the like, and this metal foil may for example be etched or rolled.

From the viewpoint of attaining compactness and lightweightness of the electrode, the thickness of this charge collector 16 is preferably 15-50 μm, but more preferably 15-30 μm.

The active substance-containing layer 18 is formed on the charge collector 16, and is a layer which contributes to accumulation and discharge of charge. This active substance-containing layer 18 mainly comprises the electrode active substance, a conductive auxiliary agent and a binder.

The electrode active substance varies with the type of electrochemical device, but when the electrochemical device is an electrical double layer capacitor, for example, porous particles having electron conductivity which contribute to electron charging/discharging are used as the electrode active substance. The porous particles may for example be granular or fibrous fully activated active carbon. More specifically, the active carbon may for example be phenolic active carbon or coconut shell active carbon.

In the present invention, it will be assumed that “capacitor” is synonymous with “condenser.”

When the electrochemical device is a lithium ion secondary battery, the electrode active substance will differ depending on whether the electrode is the anode or cathode. When the electrode is the anode, the electrode active substance may for example be a carbon material such as graphite, poorly graphitized carbon or well graphitized carbon or low temperature calcinated carbon which can occlude/release (intercalate/de-intercalate, or undergo doping/dedoping with) lithium ions, a metal which can combine with lithium such as Al, Si or Sn, an amorphous compound having an oxide such as SiO₂ or SnO₂ as its main component, and lithium titanate (Li₃Ti₅O₁₂).

When the electrode is the cathode, the electrode active substance may for example be lithium cobaltate (LiCoO₂), lithium nickelate (LiNiO₂), lithium manganese spinel (LiMn₂O₄), the composite metal oxide expressed by the general formula: LiNiₓMn_{y}CozO₂ (x+y+z=1), lithium vanadium compounds, V₂O₅, olivine type LiMPO₄ (where, M is Co, Ni, Mn or Fe), or lithium titanate (Li₃Ti₅O₁₂).

A conductive auxiliary agent is added if needed. This conductive auxiliary agent is not particularly limited provided that it is a substance having an electron conductivity which can adequately promote charge transfer between the charge collector 16 and active substance-containing layer 18, for example carbon black.

The above carbon black may be acetylene black, Ketjen black or furnace black, but in the present invention, acetylene black is preferred.

There is no particular limitation on the binder provided that it can bind the electrode active substance and conductive auxiliary agent, but examples are polytetrafluoroethylene (PTFE), polyvinylidene fluoride (PVDF), polyethylene (PE), polypropylene (PP) and fluoride rubber.

The above fluoride rubber may for example be vinylidene fluoride-hexafluoropropylene fluoride rubber (VDF-HFP fluoride rubber), vinylidene fluoride-hexafluoropropylene-tetrafluoroethylene fluoride rubber (VDF-HFP-TFE fluoride rubber), vinylidene fluoride-pentafluoropropylene fluoride rubber (VDF-PFP fluoride rubber), vinylidene fluoride-pentafluoropropylene-tetrafluoroethylene fluoride rubber (VDF-PFP-TFE fluoride rubber), vinylidene fluoride-perfluoromethylvinylether-tetrafluoroethylene fluoride rubber (VDF-PFMVE-TFE fluoride rubber) or vinylidene fluoride-chlorotrifluoroethylene fluoride rubber (VDF-CTFE fluoride rubber), but it is preferred that it is a fluoride rubber which is a copolymer of at least two moieties selected from among a group consisting of VDF, HFP and TFE, and from the viewpoint that adhesion properties and reagent resistance tend to improve, particularly preferred that it is a VDF-HFP-TFE fluoride rubber which is a copolymer of three moeities selected from among the above group.

From the viewpoint of obtaining compactness and lightweightness of the electrode, the thickness of the active substance-containing layer 18 containing these aforesaid components is preferably 50-200 μm, but more preferably 80-150 μm.

In the electrode 10, the active substance-containing layer 18 comprises an edge part 18a and a center part 18b surrounded by the edge part 18a, wherein the edge part 18a and center part 18b are given heating/pressurizing treatment. In other words, the entire substance-containing layer 18 is given heating/pressurizing treatment. The film thickness D1 of the edge part 18a of the active substance-containing layer 18 is less than the film thickness D2 of the center part 18b, and the shape of the edge part 18a of the active substance-containing layer 18 is tapered toward the outside of the center part 18b.

Hence, in the electrode 10, since the mechanical strength of the edge part 18a of the active substance-containing layer 18 is much improved and there is no right angle or acute angle in the edge part 18a, chipping and peeling of the active substance-containing layer 18 can be adequately suppressed when the electrochemical device is formed. Since the heating/pressurizing treatment is given to the whole active substance-containing layer 18 (edge part 18a and center part 18b), the density of the active substance-containing layer 18 is much improved, and superior volumetric capacity can be obtained.

It is also preferred that the value of the ratio (D1/D2) of the decreased film thickness D1 of the edge part 18a and the film thickness D2 of the center part 18b of the active substance-containing layer 18 satisfies the following relation:
0.01≦(D1/D2)≦0.4

Here, if the value of (D1/D2) is less than 0.01, as compared with the case where the value of (D1/D2) is within the above range, the mechanical strength of the edge part of the active substance-containing layer 18 is insufficient, and chipping and peeling of the active substance-containing layer 18 can no longer be adequately suppressed. On the other hand, if the value of (D1/D2) exceeds 0.4, as compared with the case where the value of (D1/D2) is within the above range, the edge part 18a of the active substance-containing layer 18 is compressed too much, and when the electrochemical device is formed, the electrolytic solution does not easily permeate the active substance-containing layer, the size of the double layer interface decreases, and it is difficult to obtain sufficient volumetric capacity.

In order to more adequately obtain the effect of the present invention described above, the angle θ of the taper in the edge part 18a is preferably 0.1-80°, but more preferably 1-45.

Moreover, in order to more adequately obtain the effect of the present invention decribed above, the width W of the edge part 18a of the active-substance-containing-layer 18 is preferably 10-1000 μm, and more preferably 20-100 μm.

Next, a preferred embodiment of the electrode manufacturing method of the present invention for manufacturing the above electrode 10, will be described.

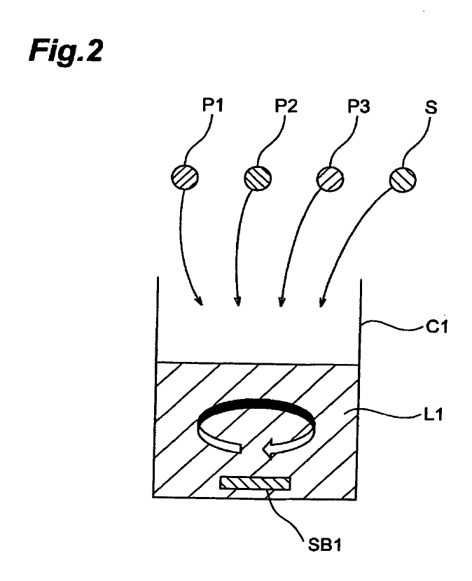

FIG. 2 is a view for describing a step for preparing an electrode-forming coating solution.

First, as shown in FIG. 2, the electrode-forming coating solution is prepared by introducing an electrode active substance P1, conductive auxiliary agent P2, binder P3 and solvent S capable of dissolving or dispersing the binder P3, and capable of dispersing the electrode active substance P1 and conductive auxiliary agent P2, into a container C1 fitted with a stirrer SB1, and stirring.

When the component materials of the anode and cathode differ, for example, when manufacturing a secondary battery as the electrochemical device, two kinds of electrode-forming coating solutions containing different component materials are prepared.

Alternatively, a kneaded material may be prepared by for example kneading the conductive auxiliary agent P2 and binder P3 with the electrode active substance P1, without preparing the above electrode-forming coating solution, and a sheet-like active substance-containing layer may be manufactured by rolling this kneaded material into a sheet. In this case, it is preferred that the electrode active substance P1 and conductive auxiliary agent P2 are uniformly distributed and bound by the binder P3 with a substantially identical strength. For this purpose, kneading is performed thoroughly, and in general, it is preferred that rolling is repeatedly performed vertically and horizontally. Thus, when the sheet-like active substance-containing layer is manufactured, an electrode sheet can for example be obtained by sticking it on a charge collector using conductive particles.

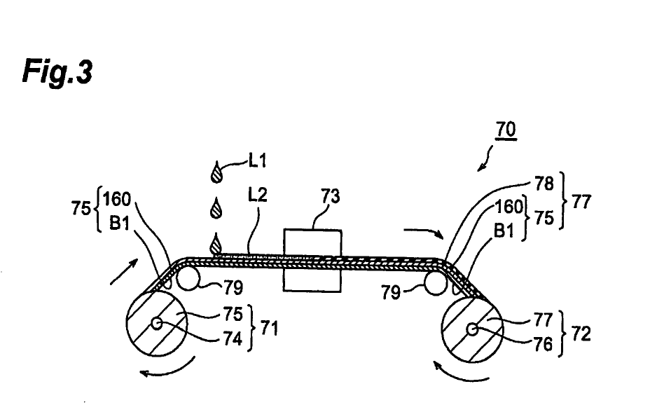

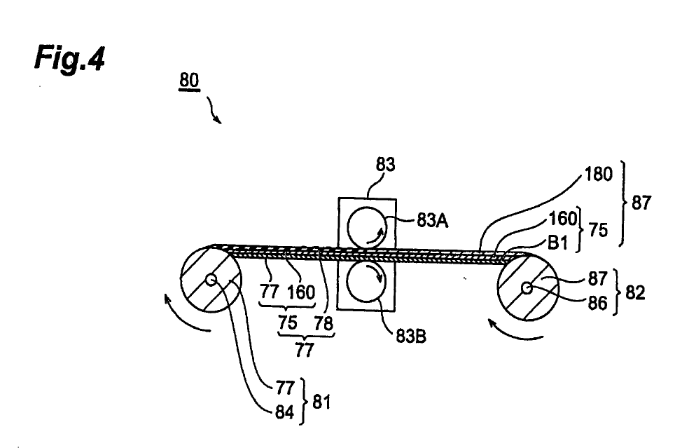

Next, an electrode sheet ES10 is formed using the above electrode-forming coating solution, and the device 70 and device 80 as shown in FIG. 3 and FIG. 4. Here, FIGS. 3 and 4 are views for describing a step for forming the electrode sheet ES10 respectively. More specifically, FIG. 3 is a view for describing a step for obtaining a laminate by coating the electrode-forming coating solution on a charge collector and drying, and FIG. 4 is a view for describing a step for obtaining an electrode sheet by pressing the above laminate in a roll press.

The device 70 shown in FIG. 3 mainly comprises a first roller 71, second roller 72, drier 73 disposed between the first roller 71 and second roller 72, and two support rollers 79. The first roller 71 comprises a cylindrical core 74 and a tape-like laminated sheet 75. One end of this laminated sheet 75 is connected to the core 74, the laminated sheet 75 being wound around the core 74. The laminated sheet 75 has a construction wherein a sheet-like charge collector 160 is laminated on a base sheet B1. Here, the charge collector 160 may for example be a metal foil sheet.

The second roller 72 has a cylindrical core 76 to which the other end of the above laminated sheet 75 is connected. A core drive motor for rotating the core 76 (not shown) is connected to the core 76 of the second roller 72, and the laminated sheet 77 after application of the electrode-forming coating solution L1 and drying treatment in the drier 73 is wound at a predetermined speed. First, when the core drive motor rotates, the core 76 of the second roller 72 rotates, and the laminated sheet 75 wound around the core 74 of the first roller 71 is paid out from the first roller 71. Next, the electrode-forming coating solution L1 is applied to the charge collector 160 of the paid-out laminated sheet 75. A film L2 of the electrode-forming coating solution L1 is thereby formed on the charge collector 160. Next, once the film L2 is formed, the laminated sheet 75 is transported to the drier 73 by the rotation of the core drive motor. In the drier 73, the film L2 on the laminated sheet 75 is dried, and becomes a precursor layer 78. This precursor layer 78 is a layer which is the precursor of the active substance-containing layer 180 when the electrode sheet is formed. Due to the rotation of the core drive motor, the laminated sheet 77 having the precursor layer 78 on the laminated sheet 75, is transported to the core 76 by the support rollers 79, and wound around the core 76.

Next, the electrode sheet ES10 is manufactured using the laminated sheet 77 and the device 80 shown in FIG. 4.

The device 80 shown in FIG. 4 mainly comprises a first roller 81, a second roller 82, and a roll press 83 disposed between the first roller 81 and second roller 82. The first roller 81 comprises a cylindrical core 84, and the tape-like laminated sheet 77 described previously. One end of this laminated sheet 77 is connected to the core 84, the laminated sheet 77 being wound around the core 84. The laminated sheet 77 has a construction wherein the precursor layer 78 is further laminated on the laminated sheet 75, the charge collector 160 being laminated on the base sheet B1.

The second roller 82 has a cylindrical core 86 to which the other end of the above laminated sheet 77 is connected. A core drive motor, not shown, for rotating this core 86 is connected to the core 86 of the second roller 82, and a laminated sheet 87 after heat-treatment and pressure treatment in the roll press 83, is wound at a predetermined speed.

First, when the core drive motor rotates, the core 86 of the second roller 82 rotates, and the laminated sheet 77 wound around the core 84 of the first roller 81 is pulled outside the first roller 81. Next, due to the rotation of the core drive motor, the laminated sheet 77 is transported to the roll press 83. In the roll press 83, two cylindrical rollers 83A, 83B are provided. This roller 83A and roller 83B are arranged so that the laminated sheet 77 may be inserted between them.

When the laminated sheet 77 is inserted between the roller 83A and roller 83B, the side face of the roller 83A comes in contact with the outer surface of the precursor layer 78 of the laminated sheet 77, and the side face of the roller 83B comes in contact with the outer surface (undersurface) of the base sheet B1 of the laminated sheet 77, so the laminated sheet 77 can be heat-treated under pressure at a predetermined temperature and a predetermined pressure.

The cylindrical roller 83A and cylindrical roller 83B comprise a rotating mechanism which rotates roller 83A and 83B in directions such that they both follow the transport direction of the laminated sheet 77. This cylindrical roller 83A and cylindrical roller 83B are of such a size that the length between their respective base surfaces is equal to or greater than the width of the laminated sheet 77. In the roll press 83, the precursor layer 78 on the laminated sheet 77 is heated and pressure-treated as required, so forming the active substance-containing layer 180. Due to the rotation of the core drive motor, the laminated sheet 87 wherein the active substance-containing layer 180 has been formed on the laminated sheet 77, is wound around the core 86.

The electrode sheet ES10 is then obtained by cutting this laminated sheet 87 as required.

Next, the obtained electrode sheet ES10 is cut to a predetermined size for use as an electrode which forms part of an electrochemical device (cutting step).

Here, the method used to cut the electrode sheet may for example be a method such as cutting or punching.

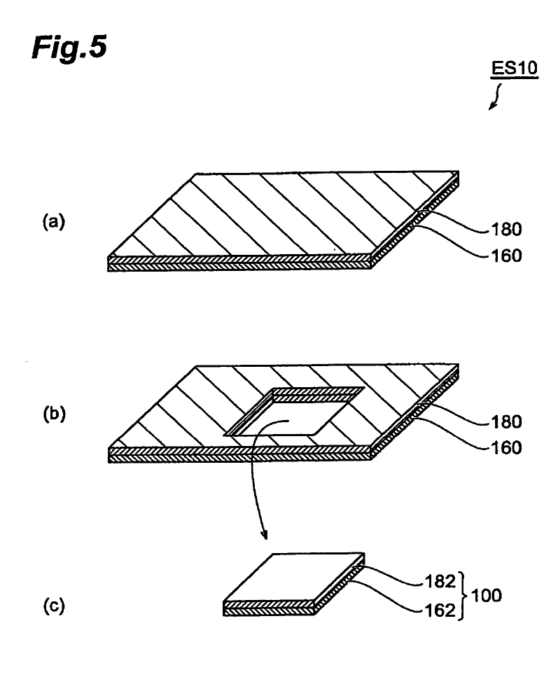

(a)-(c) of FIG. 5 show a series of steps for forming an electrode element 100 from the electrode sheet ES10.

First, the electrode sheet ES10 shown in (a) of FIG. 5 is prepared. Next, the prepared electrode sheet ES10 is punched out according to the scale of the electrochemical device to be manufactured, as shown in (b) of FIG. 5. In this way, the charge collector 160 in the electrode sheet ES10 is cut to form a charge collector 162, the active substance-containing layer 180 is cut to form an active substance-containing layer 182, and the electrode element 100 comprising the charge collector 162 and active substance-containing layer 182 is thereby obtained as shown in FIG. 5(c).

Here, the risk of chipping and peeling in the active substance-containing layer 182 may vary depending on the punching direction when the electrode element 100 is punched out from the electrode sheet ES10. Specifically, when a cutting die is brought into contact from the side of the active substance-containing layer 180 of the electrode sheet ES10 to punch the sheet, a stress acts on the active substance-containing layer 180 in the direction in which he active substance-containing layer 180 adheres to the charge collector 160, so chipping and peeling do not occur easily, but conversely, when the cutting die is brought into contact from the side of the charge collector 160, a stress acts on the active substance-containing layer 180 in a direction away from the charge collector 160, so chipping and peeling occur relatively easily.

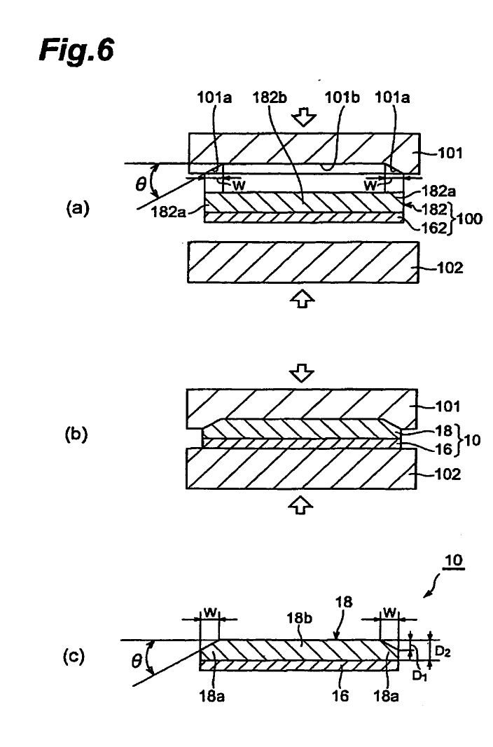

Therefore, in order to restore chipping and peeling produced in the active substance-containing layer 182, heating/pressurizing treatment is given to at least the edge part of the active substance-containing layer 182 in the electrode element 100 (heating/pressurizing treatment step). Here, the heating/pressurizing treatment given to the above electrode element 100 will be described referring to (a)-(c) of FIG. 6.

(a)-(c) of FIG. 6 show a series of steps for giving heating/pressurizing treatment to the electrode element 100. As shown in (a) of FIG. 6, the electrode element 100 is arranged between a plate-like metal mold 101 and a plate-like metal mold 102 which are a pair of heating members constituting a heat press. Here, the surface (heating surface) in contact with the electrode element 100 of the metal mold 101 and the surface (heating surface) in contact with the electrode element 100 of the metal mold 102, are both set to a size equal to or larger than the electrode element 100. The metal mold 101 in contact with the surface on the side of the active substance-containing layer 182 of the electrode element 100 has a depression, this depression having a flat surface 101b and an inclined surface 101a inclined with respect to the flat surface 101b which extends from the flat surface 101b. The flat surface 101b comes in contact with the center part 182b of the active substance-containing layer 182, and the inclined surface 110a comes in contact with the edge part 182a of the active substance-containing layer 182.

As shown in (b) of FIG. 6, the electrode element 100 is pressurized by gripping the electrode element 100 between the heated mold 101 and heated mold 102, and applying a pressure in the thickness direction of the active substance-containing layer 182. In this way, heating/pressurizing treatment is given to the edge part 182a and center part 182b of the active substance-containing layer 182.

Due to this, the charge collector 162 in the electrode element 100 becomes a charge collector 16, the active substance-containing layer 182 becomes an active substance-containing layer 18, and as shown in FIG. 6(c), the electrode 10 is formed by the charge collector 16 and the active substance-containing layer 18 wherein heating/pressurizing treatment has been given to the whole active substance-containing layer 18 (edge part 18a and center part 18b).

In the active substance-containing layer 18 of this electrode 10, the decreased film thickness D1 of this edge part 18a is less than the maximum film thickness D2 of the center part 18b, and the shape of the edge part 18a is tapered towards the outside of the center part 18b of the active substance-containing layer 18 (tapered shape).

Due to performing the above heating/pressurizing treatment so that the edge part 18a has such a tapered shape, when cutting the electrode sheet ES10 to obtain the electrode element 100, even in the case where chipping and peeling occurs in the cut part of the active substance-containing layer 182 of the electrode element 100, this chipping and peeling can be adequately restored, and in the obtained electrode 10 comprising the active substance-containing layer 18, chipping and peeling are adequately prevented. Further, the mechanical strength of the edge part 18a of the active substance-containing layer 18 is much improved, and chipping and peeling of the active substance-containing layer 18 during manufacture of the electrochemical device can be adequately suppressed. In particular, in the above heating/pressurizing treatment, by compressing the edge part 18a so that it has a tapered shape, right angles and acute angles in the edge part 18a of the active substance-containing layer 18 are eliminated, so chipping and peeling of the active substance-containing layer 18 during manufacture of the electrochemical device can be more adequately suppressed.

Moreover, due to the aforesaid heating/pressurizing treatment, by giving heating/pressurizing treatment to the edge part 182a and center part 182b of the active substance-containing layer 182, the density of the active substance-containing layer 18 after heating/pressurizing treatment is much improved, and the volumetric capacity of the electrode 10 can be improved.

It is preferred that the value of the ratio (D1/D2) of the decreased film thickness film thickness D1 of the edge part 18a of the active substance-containing layer 18, and the maximum film thickness D2 of the center part 18a, satisfies the relation:
0.01≦(D1/D2)≦0.4.

Here, if the value of (D1/D2) is less than 0.01, as compared with the case where the value of (D1/D2) is within the above range, the restoration of chipping and peeling of the active substance-containing layer, and the improvement of mechanical strength of the edge part of the active substance-containing layer, tend to be insufficient. On the other hand, if the value of (D1/D2) exceeds 0.4, as compared with the case where the value of (D1/D2) is within the above range, the edge part of the active substance-containing layer is compressed too much, and when the electrochemical device is formed, the electrolytic solution does not easily permeate the active substance-containing layer, the size of the double layer interface decreases, and it may be difficult to obtain sufficient volumetric capacity.

In order to more adequately obtain the effect of the present invention described above, the angle θ of the taper in the edge part 18a is preferably 0.1-80°, but more preferably 1-45°.

In order to more adequately obtain the effect of the present invention described above, the width W of the edge part 18a of the active-substance-containing-layer 18 is preferably 10-1000 μm, but more preferably 20-100 μm.

When performing the aforesaid heating/pressurizing treatment, the temperature is preferably 100-250° C., but more preferably 150-210° C. If the temperature during heating/pressurizing treatment is lower than the aforesaid lower limiting value, compared to the case where the temperature is within the above range, it tends to be difficult to adequately restore chipping and peeling of the active substance-containing layer 18, and if the temperature exceeds the above limiting value, compared to the case where the temperature is within the above range, the binder in the active substance-containing layer 18 tends to decompose, so the mechanical strength of the active substance-containing layer 18 tends to fall.

When performing the aforesaid heating/pressurizing treatment, the pressure is preferably 0.098 MPa or more, but more preferably 0.098-98 MPA. If the pressure during heating/pressurizing treatment is lower than the above lower limiting value, compared to the case where the pressure is within the above range, it tends to be difficult to adequately restore chipping and peeling of the active substance-containing layer 18.

In order to obtain the aforesaid effect of the invention, the treatment time of the heating/pressurizing treatment is preferably 1-600 seconds, but more preferably 5-90 seconds.

When performing the aforesaid heating pressurizing treatment, the solvent content of the active substance-containing layer 182 is preferably 20 mass % or less, but more preferably 5 mass % or less. If the solvent content exceeds the above upper limiting value, compared to the case where the solvent content is within the above range, the surface of the active substance-containing layer 182 tends to stick to the mold 101 during heating/pressurizing treatment, and chipping and peeling of the active substance-containing layer 18 consequently tend to occur more easily.

In the step for manufacturing the laminated sheet 77 using the device 70 shown in FIG. 3, the above solvent content can be adjusted to within the above range by adequately removing solvent in the drier 73. Also, if required, the solvent content can be reduced by performing drying treatment prior to the aforesaid heating/pressurizing treatment.

Hereinabove, a preferred embodiment of the electrode and electrode manufacturing method of the invention has been described, but the present invention is not limited to the aforesaid embodiment.

For example, to form a part which functions as an external output terminal on the electrode 10, a lead which functions as an external output terminal may be preferred if required, and this lead may be electrically connected to the electrode 10. Also, to obtain the electrode 10 provided with an external output terminal beforehand, the electrode sheet ES10 having an edge part in which the surface of collector 160 is exposed, is prepared, and the electrode sheet ES10 then may be punched out to form the electrode element 100 so that this edge is included as a lead. By performing heating/pressurizing treatment of the electrode element 100, the electrode 10 wherein the lead part is formed in a one-piece construction beforehand can thus be obtained. In this case, the above edge may be formed during coating of the electrode-forming coating solution L1 on the charge collector 160 of the laminated sheet 75, by making adjustments so that the electrode-forming coating solution L1 is coated only in the center part of the charge collector 160.

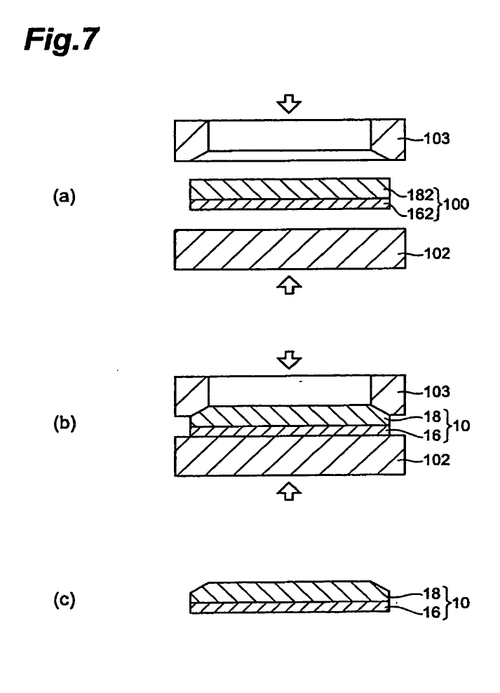

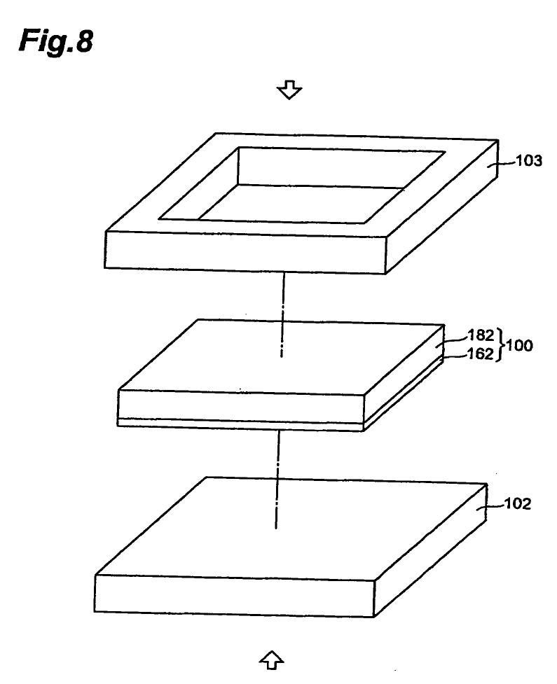

Also, in the electrode manufacturing method of the invention, the shape of the mold used when performing the heating/pressurizing treatment is not limited to the shape of the above mold 101, and may be any shape which permits heating/pressurizing treatment to be given to at least the edge part 182a of the active substance-containing layer 182. Specifically, as shown in (a)-(c) of FIG. 7 and FIG. 8, the heating/pressurizing treatment may also be performed using a square annular mold 103 which permits heating/pressurizing treatment to be given to at least the edge part 182a of the active substance-containing layer 182. If this mold 103 is used, since heating/pressurizing treatment is given to the edge part of the active substance-containing layer 18, when the electrode sheet ES10 is cut to obtain the electrode element 100, even if chipping and peeling occurs in the cut part of the active substance-containing layer 182 of the electrode element 100, this chipping and peeling can be adequately restored, and the electrode 10 comprising the active substance-containing layer 18 free of chipping and peeling can be obtained. Also, the mechanical strength of the edge part 18a of the active substance-containing layer 18 is much improved, and chipping and peeling of the active substance-containing layer 18 during manufacture of the electrochemical device can be adequately suppressed. In particular, since the edge part 18a is compressed to a tapered shape, right angles or acute angles in the edge part 18a of the active substance-containing layer 18 are eliminated, and chipping and peeling of the active substance-containing layer during manufacture of the electrochemical device can be adequately suppressed.

If heating/pressurizing treatment is given only to the edge part 18a of the active substance-containing layer 18 in this way, it is not absolutely necessary to simultaneously give heating/pressurizing treatment to the entire edge part, and the heating/pressurizing treatment may be given to every one side of the edge part sequentially. In this case, for example, the heating/pressurizing treatment may be performed using a commercial impulse sealer. In this process, the treatment time of the heating/pressurizing treatment is preferably 1 second or more, but more preferably 5-90 seconds.

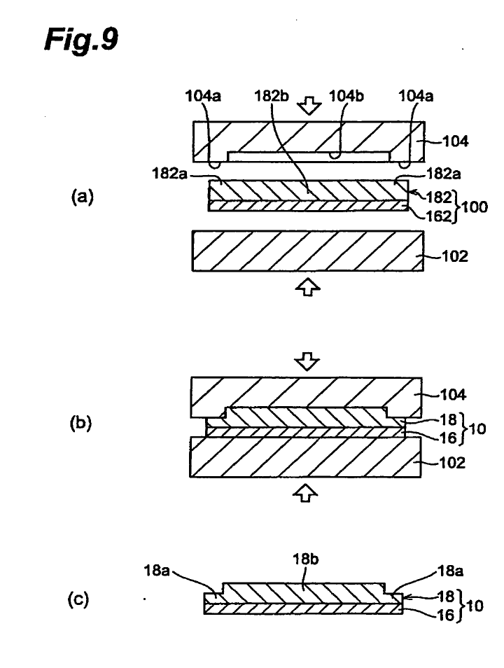

Also, when performing the above heating/pressurizing treatment, the part in contact with the edge part 182a of the active substance-containing layer 182 need not necessarily be an inclined surface as in the above mold 101. Specifically, as shown in (a)-(c) of FIG. 9, the heating/pressurizing treatment may be performed using a mold 104 wherein the part in contact with the edge part 182a of the active substance-containing layer 182 is a flat surface 104a parallel to a flat surface 104b in contact with the center part 182b of the active substance-containing layer 182. Even if this type of mold 104 is used, chipping and peeling of the active substance-containing layer 182 can be adequately restored, and chipping and peeling of the active substance-containing layer 18 when the electrochemical device is manufactured, can be adequately suppressed. Further, since heating/pressurizing treatment is given to the whole of the active substance-containing layer 18, the density of the active substance-containing layer 18 improves, and the volumetric capacity can be improved.

The manufacturing method of the present invention also includes the case where an electrode having the active substance-containing layer formed on both surfaces of the charge collector, is manufactured.

In this case, for example, after forming the active substance-containing layer on one surface of the charge collector by the method described using FIG. 3 and FIG. 4, the active substance-containing layer is formed on the other surface of the charge collector by the same method so as to obtain an electrode sheet wherein the active substance-containing layer is formed on both surfaces of the charge collector. This electrode sheet is then cut to a predetermined size so as to manufacture the electrode element 130.

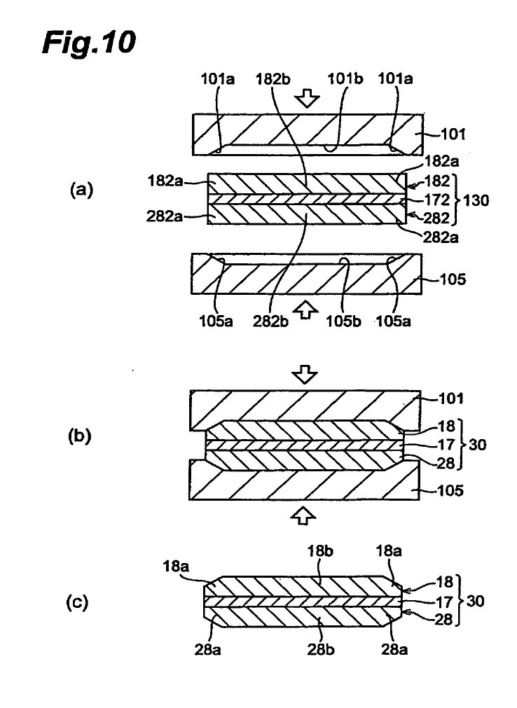

(a)-(c) of FIG. 10 show a sequence of steps for giving heating/pressurizing treatment to the electrode element 130 wherein the active substance-containing layer 182 is formed on one surface of a charge collector 172, and an active substance-containing layer 282 is formed on the other surface.

As shown in (a) of FIG. 10, the mold 101 has an shape similar to that of the mold 101 shown in (a) of FIG. 6, i.e., it has a depression formed by a flat surface 101b, and an inclined surface 111a inclined to the flat surface 101b which extends from the flat surface 101b. Also, a mold 105 has an shape similar to the mold 101, i.e., it has a depression formed by a flat surface 105b, and an inclined surface 105a inclined to the flat surface 105b which extends from the flat surface 105b. The flat surface 101b comes in contact with the center part 182b of the active substance-containing layer 182, and the inclined surface 111a comes in contact with the edge part 182a of the active substance-containing layer 182. Likewise, the flat surface 105b comes in contact with the center part 282b of the active substance-containing layer 282, and the inclined surface 105a comes in contact with the edge part 282a of the active substance-containing layer 282.

As shown in (b) of FIG. 10, by gripping the electrode element 130 between the heated mold 101 and heated mold 105, and pressing the electrode element 130, heating/pressurizing treatment can be given to the whole of the active substance-containing layer 182 and active substance-containing layer 282.

In this way, as shown in (c) of FIG. 10, an electrode 30 comprising a charge collector 17, the active substance-containing layer 18 whereof the whole is given heating/pressurizing treatment, and an active substance-containing layer 28 whereof the whole is given heating/pressurizing treatment, is formed. In the active substance-containing layer 18 of this electrode 30, the minimum film thickness of the edge part 18a is less than the maximum film thickness of the center part 18b, and the shape of the edge part 18a is tapered towards the outside of the center part of the active substance-containing layer 18. Moreover, in the active substance-containing layer 28, the minimum film thickness of the edge part 28a is less than the maximum film thickness of the center part 28b, and the shape of the edge part 28a is tapered towards the outside of the center part of the active substance-containing layer 28. When the electrochemical device is a lithium ion secondary battery, one of the active substance-containing layer 18 and active substance-containing layer 28 is manufactured as a layer containing an anode electrode active substance, while the other is manufactured as a cathode electrode active substance.

In this way, even if the active substance-containing layer is formed on both surfaces of the charge collector, by performing heating/pressurizing treatment so that the edge part 18a and edge part 28a have the above shapes, the electrode 30 comprising the active substance-containing layer 18 and the active substance-containing layer 28, wherein chipping and peeling are adequately suppressed, can thus be obtained. Further, the mechanical strength of the edge part 18a of the active substance-containing layer 18 and edge part 28a of the active substance-containing layer 28 is much improved, so chipping and peeling of the active substance-containing layer 18 and active substance-containing layer 28 during manufacture of the electrochemical device can be adequately suppressed. In particular, by compressing the edge part 18a and edge part 28a to a tapered shape, right angles or acute angles in the edge part 18a of the active substance-containing layer 18 and edge part 28a of the active substance-containing layer 28 are eliminated, so chipping and peeling of the active substance-containing layer 18 and active substance-containing layer 28 during manufacture of the electrochemical device can be more adequately suppressed.

Further, due to the above heating/pressurizing treatment, heating/pressurizing treatment is given to the whole of the active substance-containing layer 18 and active substance-containing layer 28, so the density of the active substance-containing layer 18 and active substance-containing layer 28 improves, and the volumetric capacity can be improved.

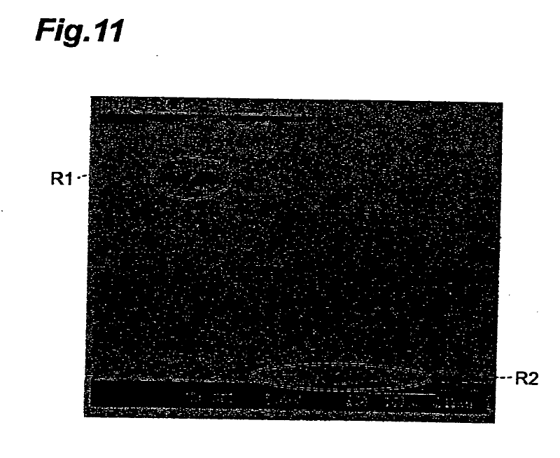

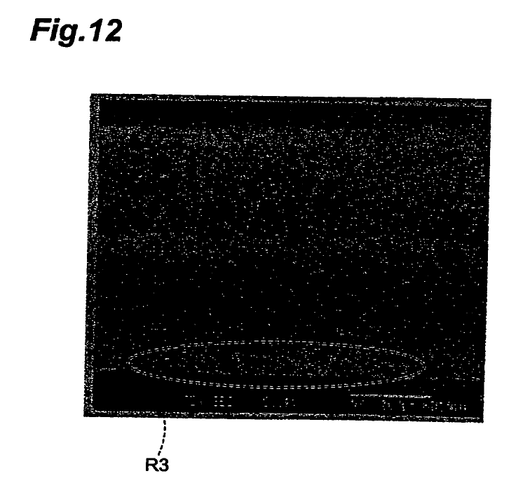

Here, FIG. 11 is an electron micrograph (magnification: 250×) of a side surface (cut surface) of the electrode element 130 prior to performing the heating/pressurizing treatment shown in (a) of FIG. 10, and FIG. 12 is an electron micrograph (magnification: 250×) of a side surface (cut surface) of the electrode 30 after performing the heating/pressurizing treatment shown in (c) of FIG. 10. The electrode element 130 and the electrode 30 have been punched out using a cutting die from the lower part of the figure. As shown in FIG. 11 and FIG. 12, in the electrode element 130 prior to heating/pressurizing treatment, peeling of the active substance-containing layer was observed (region R1 in FIG. 11) and burrs of the surface of the active substance-containing layer was observed (region R2 in FIG. 12), but in the electrode 30 after heating/pressurizing treatment, chipping and peeling of the active substance-containing layer were not observed, and there were no burrs (region R3 in FIG. 12). Also, in the electrode 30 shown in FIG. 12, the edge part of the active substance-containing layer was pressed, and it was found that the film thickness of the edge part was less than the film thickness of the center part (region R3 in FIG. 12).

The above heating/pressurizing treatment may also be performed using a roll press. In this case, for example, the electrode shown in FIG. 6-10 can be manufactured by disposing a mold as shown in FIG. 6-10 on a roller surface to perform the heating/pressurizing treatment. The electrode of the present invention is not limited to that shown in FIG. 1, and may for example be an electrode manufactured by the aforesaid manufacturing method of the invention, i.e., it may be the electrode shown in (c) of FIG. 7, (c) of FIG. 9 and (c) of FIG. 10.

(Electrochemical device and electrochemical device manufacturing method)

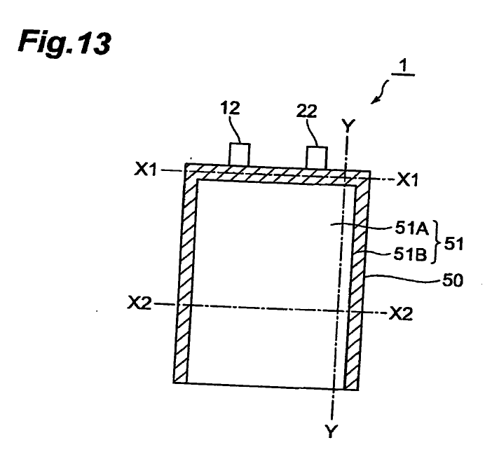

FIG. 13 is a front view showing one preferred embodiment (electrical double layer capacitor) of an electrochemical device according to the invention. The electrochemical device 1 of FIG. 13 is manufactured by a preferred embodiment of the electrochemical device manufacturing method of the invention.

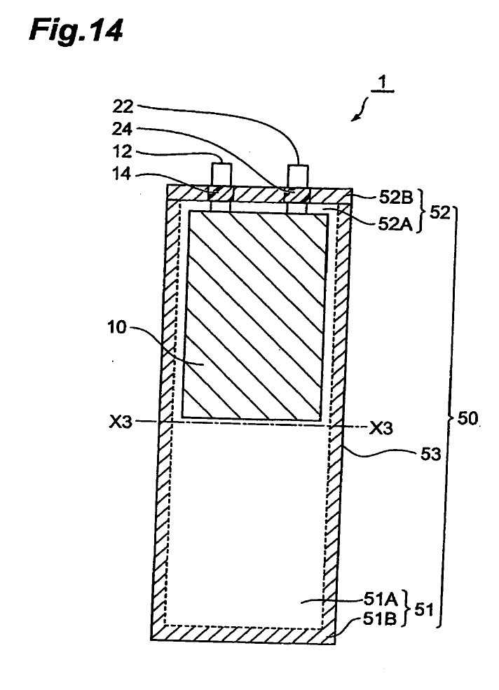

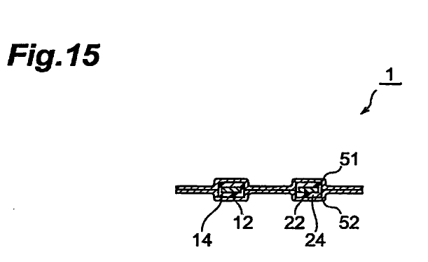

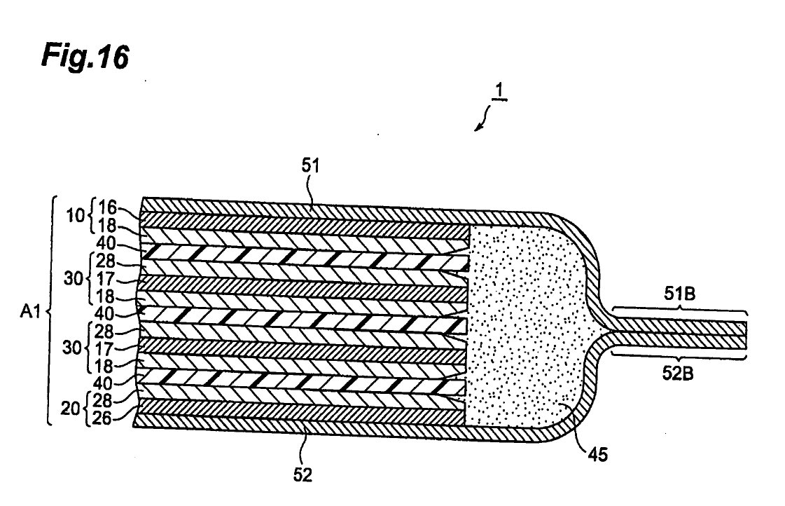

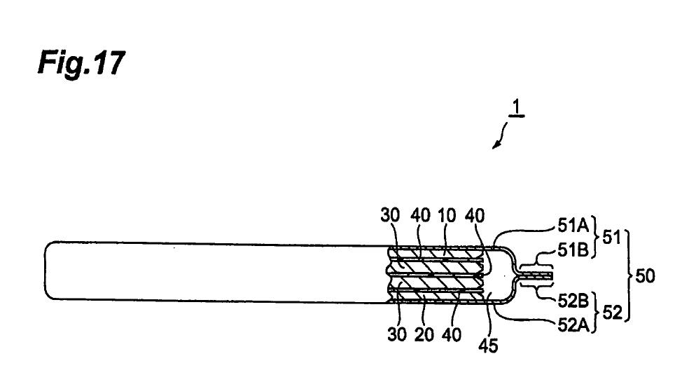

FIG. 14 is a cutaway view when the interior of the electrochemical device 1 shown in FIG. 13 is viewed from the normal direction of the surface of the anode 10. Also, FIG. 15 is a schematic cross-sectional view when the electrochemical device 1 shown in FIG. 13 is cut along a line X1-X1. FIG. 16 is a schematic cross-sectional view showing essential parts when the electrochemical device 1 shown in FIG. 13 is cut along a line X2-X2 in FIG. 13. FIG. 17 is a schematic cross-sectional view of essential parts when the electrochemical device 1 shown in FIG. 13 is cut along a line Y-Y in FIG. 13.

As shown in FIG. 13-FIG. 17, the electrical double layer capacitor 1 mainly comprises the anode 10, cathode 20, two electrodes 30 disposed between the anode 10 and cathode 20, separators 40 respectively disposed between these four electrodes, an electrolytic solution 45, and a case 50 housing these such that they are sealed inside.

An anode lead 12 is provided on the collector (anode charge collector) 16, one end of anode lead 12 is electrically connected to the charge collector 16 of the electrical double layer capacitor 1, and the other end of anode lead 12 extends outside the case 50. Also, cathode lead 22 is provided on the collector (cathode charge collector) 26, one end of cathode lead 22 is electrically connected to the charge collector 26 of the electrical double layer capacitor 1, and the other end is extends outside the case 50. For simplicity, the terms “anode” and “cathode” used in the description of the electrical double layer capacitor 1 are based on the polarity of the electrical double layer capacitor 1 during discharge.

The electrical double layer capacitor 1 has the construction described below. The component elements of this embodiment of the invention will now be described referring to FIG. 13-FIG. 19. First, the case 50 will be described. The case 50 comprises a first film 51 and a second film 52 which are opposite to each other. Here, as shown in FIG. 14, the first film 51 and second film 52 in this embodiment are connected together. Specifically, the case 50 in this embodiment is formed from a rectangular film comprising one sheet of composite packaging film, which is bent along the bending line X3-X3 shown in FIG. 14 so that one set of opposite edges of the rectangular film (edge SIB of the first film 51 and edge 52B of the second film 52 in the FIG.) are superimposed and glued, or heat-sealed.

The first film 51 and second film 52 respectively mean film parts having opposite surfaces formed when one rectangular film is bent as described above. Here, in this specification, the edge regions of the surface (hereafter, film “inner surface” of each film) on the side where the first film 51 and second film 52 forming the case 50 are heat-sealed or stuck together using an adhesive, or the respective edges of the first film 51 and second film 52 when the first film 51 and second film 52 are joined together, are referred to as “seal parts”.

Due to this, there is no need to provide a seal part to join the first film 51 and second on 52 in the part of the bending line X3-X3, so the seal parts in the case 50 can be further reduced. As a result, the volumetric energy density based on the volume of the space where the electrical double capacitor 1 is to be installed, can be further improved.

Here, “volumetric energy density” is originally defined as the proportion of total output energy relative to the total volume comprising the container of the electrical double layer capacitor (electrochemical device). Conversely, “volumetric energy density based on the volume of the space where components are to be installed” means the proportion of total output energy of the electrical double capacitor (electrochemical device) relative to the apparent volume based on the maximum height, maximum breadth and maximum thickness. In practice, if the electrical double layer capacitor (electrochemical device) is mounted in a compact electronic instrument, the aforesaid original volumetric energy density improves, and the volumetric energy density based on the volume of the space where components are to be installed improves, which is important from the viewpoint of effectively using the limited space inside the compact electronic instrument so that dead space is effectively minimized.

Here, the first film 51 and the second film 52 are flexible films.

In this embodiment, as shown in FIG. 13 and FIG. 14, one end respectively of the anode lead 12 connected to the anode charge collector 16 and the cathode lead 22 connected to the cathode charge collector 26 are disposed so that they extend outside the seal part which joins the edge 51B of the first film 51 to the edge 52B of the second film 52.

Also, as described above, the films forming the first film 51 and second film 52 are flexible films. As these films are lightweight and can be easily made thin, the electrical double layer capacitor 1 itself can also be made a thin film. Therefore, the actual volumetric energy density can be easily improved, and the volumetric energy density based on the volume of the space where the electrical double layer capacitor 1 is to be installed, can also be easily improved.

The films are not particularly limited provided that they are flexible films, but from the viewpoint of securing sufficient mechanical strength and lightweightness, and effectively preventing water or air from entering the inside of the case from outside the case, and dispersion of electrolyte components from inside the case to the outside of the case, they are preferably “composite packaging films” comprising at least an innermost layer of a synthetic resin in contact with the electrolytic solution, and a metal layer provided on the innermost layer.

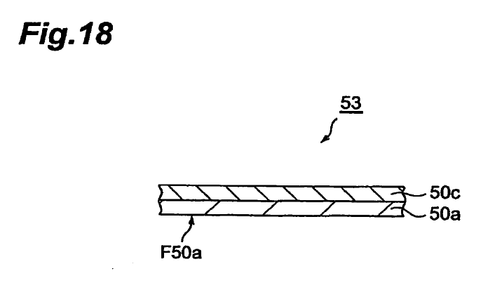

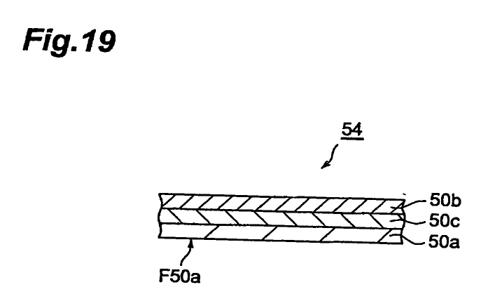

The composite packaging film which can be used as the first film 51 and second film 52 may for example be a composite packaging film having the construction shown in FIG. 18 and FIG. 19. A composite packaging film 53 shown in FIG. 18 comprises an innermost layer 50a of synthetic resin in contact with the electrolytic solution at the inner surface F50a, and a metal layer 50c provided on the other surface (outer surface) of the innermost layer 50a. Also, a composite packaging film 54 shown in FIG. 19 further comprises an outermost layer 50b of a synthetic resin on the outer surface of the metal layer 50c of the composite packaging film 53 shown in FIG. 1.

The composite packaging film which can be used as the first film 51 and second film 52 is not particularly limited provided that it is a composite packaging material comprising two or more layers including one or more synthetic resin layers such as the aforesaid innermost layer and a metal layer such as metal foil or the like, but from the viewpoint of better attaining the aforesaid effect of the invention, as in the case of the composite packaging film 54 shown in FIG. 18, it more preferably comprises three or more layers comprising an innermost layer, an outermost layer of synthetic resin provided on the outer surface of the case 50 furthest from the innermost layer, and at least one metal layer disposed between the innermost layer and outermost layer.

The innermost layer is not particularly limited provided that it is a flexible layer, and its component material is a synthetic resin which can manifest flexibility, which has chemical stability (chemical reactions, solution or swelling do not occur) with respect to the electrolytic solution used, and which has chemical stability with respect to oxygen and water (moisture in air), but it is preferably a material having low permeability with respect to oxygen, water (moisture in air) and the components of the electrolytic solution. For example, a thermoplastic resin such as polyethylene, polypropylene, acid-modified polyethylene, acid-modified polypropylene, polyethylene ionomer and polypropylene ionomer may be mentioned.

Further, if a synthetic resin layer such as the outermost layer 50b is further provided in addition to the innermost layer 50a, as in the case of the composite packaging film 54 shown in FIG. 19, this synthetic resin layer may also use an component material similar to that of the innermost layer. This synthetic resin layer may employ a layer of engineering plastic such as for example polyethylene terephthalate (PET) or polyamide (nylon).

The method of sealing all the seal parts in the case 50 is not particularly limited, but from the viewpoint of productivity, heat sealing is preferred.

The metal layer is preferably a layer comprising a metal material having corrosion resistance to oxygen, water (moisture in air) and the electrolytic solution. For example, metal foils of aluminum, aluminum alloy, titanium and chromium may be used.

Next, a laminate A1 comprising the anode 10, cathode 20, two electrodes 30, separators 40 and electrolytic solution 45 will be described referring to FIG. 16 and FIG. 17.

In the laminate A1, the anode 10 and cathode 20 employ the electrode 10 of the present invention having the construction shown in FIG. 1. The two electrodes 30 employ the electrode 30 of the invention having the construction shown in FIG. 10(c).

The separator 40 disposed between the electrodes is not particularly limited provided that it is formed of a porous body having insulating properties, and a separator used for electrical double layer capacitors known in the art may be used. For example, the porous body with insulating properties may be a laminate of a polyethylene, polypropylene or polyolefin film, an extended film comprising a mixture of the above resins, or a non-woven fabric of at least one component material selected from a group consisting of cellulose, polyester and polypropylene.

The electrolytic solution 45 is contained inside the anode 10, cathode 20, two electrodes 30 and separators 40. The electrolytic solution 45 may also be filled in the internal space of the case 50.

This electrolytic solution 45 is not particularly limited, and may be an electrolytic solution (aqueous electrolytic solution or an electrolytic solution using an organic solvent) employed for electrical double layer capacitors known in the art. However, if the aqueous electrolytic solution electrochemically has a low decomposition voltage, the durable voltage of the capacitor is suppressed low, so an electrolytic solution (non-aqueous electrolytic solution) using an organic solvent is preferred.

The type of electrolytic solution is not particularly limited, and in general may be selected considering electrolyte solubility, degree of dissociation and viscosity of the solution, but it is preferably an electrolyte having a high conductivity and a high potential window (the decomposition start voltage is high). A typical example is a quartenary ammonium salt such as tetrathethylammonium tetrafluoroborate dissolved in an organic solvent such as propylene carbonate, diethylene carbonate or acetonitrile. In this case, water entering the system must be rigorously controlled.

Here, the “electrolytic solution” may not only be a solution, but also a gel-like electrolyte obtained by adding a gelling agent.

As shown in FIG. 13 and FIG. 14, a part of the anode lead 12 in contact with the seal part of an enclosure comprising the edge part 51B of the first film 51 and edge part 52B of the second film 52, is covered by an insulator 14 to prevent contact between the anode lead 12 and the metal layer of the composite packaging film forming each film. Further, a part of the anode lead 22 in contact with the seal part of the enclosure comprising the edge part 51B of the first film 51 and edge part 52B of the second film 52, is covered by an insulator 24 to prevent contact between the anode lead 22 and the metal layer of the composite packaging film forming each film.

The construction of the insulator 14 and insulator 24 is not particularly limited, and they may for example be respectively formed from a synthetic resin. However, provided that contact of the metal layer in the composite packaging film respectively with the anode lead 12 and cathode lead 22 can be adequately prevented, it is not necessary to provide the insulator 14 and insulator 24.

The electrochemical device (electrical double layer capacitor 1) uses the aforesaid electrode of the invention as the anode 10, cathode 20 and two electrodes 30, so chipping and peeling of the active substance-containing layer can be adequately suppressed, and short circuits between the electrodes can be adequately suppressed.

Next, a preferred embodiment of the method of manufacturing the aforesaid electrical double layer capacitor 1 will be described.

First, in the aforesaid electrode manufacturing method of the invention, the electrode 10, electrode 20 and two electrodes 30 are manufactured. After the separators 40 are disposed between these electrodes, the assembly is pressed, for example by a heat press, to obtain the one-piece laminate A1 wherein the layers are firmly stuck together as shown in FIG. 16. In this process, chipping and peeling of the electrode 10, electrode 20 and two electrodes 30 manufactured by the electrode manufacturing method of the invention are adequately prevented and the mechanical strength of the edge part is improved, so chipping and peeling of the active substance-containing layer during manufacture of the laminate A1 are adequately suppressed. Here, the electrode 10 is used as the anode and the electrode 20 is used as the cathode. Hereafter, the electrode 10 and electrode 20 will be respectively referred to as the anode 10 and cathode 20.

Next, as described above referring to FIG. 14, one film is bent, and the seal part 51B (edge part 51B) of the first film 51 and the seal part 52B (edge part 52B) of the second film 52 are for example heat-sealed to a predetermined seal width under predetermined heating conditions using a sealing machine. At this time, to secure a sufficient opening through which to introduce the laminate A1 into the case 50, a part is left where heat sealing is not performed. In this way, the case 50 having an opening is obtained.

Next, the laminate A1 wherein the anode lead conductor 12 and cathode lead 22 are electrically connected, is inserted into the interior of the case 50 having the opening. The electrolytic solution 45 is then injected. Next, the opening in the case 50 is sealed using a sealing machine with part of the anode lead 12 and cathode lead 22 respectively inserted in the case 50. This completes the manufacture of the case 50 and the electrical double layer capacitor 1. In this process, chipping and peeling of the anode 10, cathode 20 and two electrodes 30 manufactured by the electrode manufacturing method of the invention are adequately prevented and the mechanical strength of the edge part is improved, so even when the laminate A1 is inserted in the case 50, chipping and peeling of the active substance-containing layer are adequately suppressed. In this way, the electrical double layer capacitor 1 wherein short-circuits between electrodes can be adequately suppressed, is obtained.

Hereinabove, a detailed description has been given of a preferred embodiment of the electrochemical device and electrochemical device manufacturing method of the invention, but the invention is not limited to this embodiment.

For example, in the aforesaid embodiment of the invention, the invention was mainly applied to an electrical double layer capacitor, but the electrochemical device of the invention is not limited to an electrical double layer capacitor, and may for example be applied to an electrochemical device such as a pseudo-capacitor or a redox capacitor.

Further, in the aforesaid embodiment of the invention, the case was described where the electrodes were the anode 10, cathode 20 and two electrodes 30, but the electrochemical device of the invention may comprise at least the anode 10 as a first electrode and the cathode 20 as a second electrode.

Further, in the aforesaid embodiment of the invention, the invention was mainly applied to an electrochemical capacitor (in particular, an electrical double layer capacitor), but the electrochemical device of the invention is not limited thereto, and it may also be applied to a secondary battery such as a lithium ion secondary battery. In this case, the active substance-containing layer which is the first electrode (anode) contains an electrode active substance which can be used as the anode of a secondary battery such as a lithium ion secondary battery. Also, the active substance-containing layer which is the second electrode (cathode) contains an electrode active substance which can be used as the cathode of a secondary battery such as a lithium ion secondary battery.

In the present invention, in addition to forming the case from the aforesaid composite packaging film, it may be a can-shaped outer packaging (metal case) formed from a metal member. In this way, the invention may be applied when a higher mechanical strength than that of a composite packaging film is required of the case.

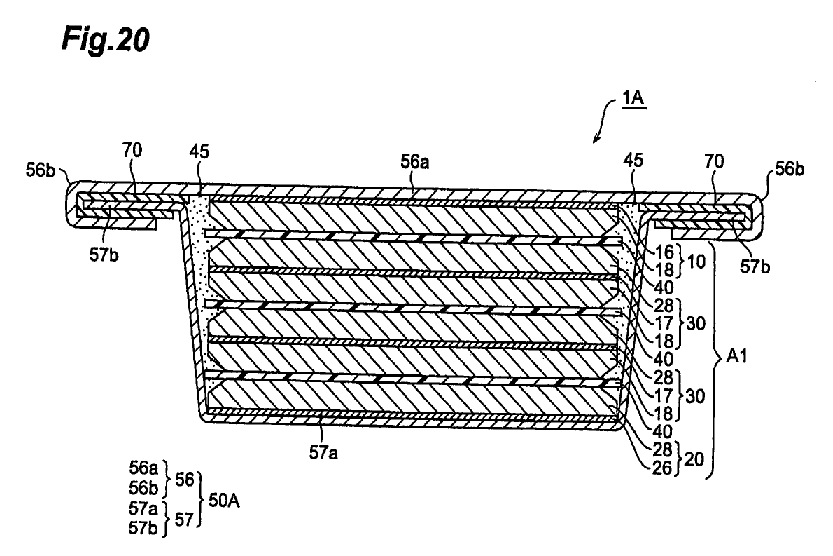

FIG. 20 is a coin-shaped electrochemical device 1A (electrical double layer capacitor) as the electrochemical device according to this embodiment of the invention.

This electrochemical device 1A mainly comprises an anode 10, cathode 20 and two electrodes 30 disposed between the anode 10 and cathode 20, and inside these four electrodes, separators 40 disposed between adjacent electrodes, an electrolytic solution 45 and a case 50A (metal can-shaped outer packaging) which houses these units sealed inside.

The electrochemical device 1A shown in FIG. 20, apart from the case 50A (metal can-shaped outer packaging), has a construction similar to that of the electric double layer capacitor 1 described using FIG. 13-FIG. 19.

The case 50A (metal can-shaped outer packaging) is a container which encloses and seals the laminate A1 comprising the anode 10, cathode 20, two electrodes 30 disposed between the anode 10 and cathode 20, and separators 40 disposed respectively between these four electrodes, from above and below, and comprises an upper cover (one metal member) 56, a lower cover (another metal member) 57, and a gasket 60 which electrically insulates the upper cover 56 and lower cover 57. The upper cover 56 and lower cover 57 enclose the laminate A1 from above and below so as to surround the laminate A1.

The lower cover 57 is formed from a metal foil such as aluminum or the like. This lower cover 57 comprises a cylindrical part 57a whereof the lower end is closed and the upper end is open, and a sheath part 57b (end) formed in a circular shape so that it extends outside from the upper end of this cylindrical part 57a. The base of the cylindrical part 57a of the lower cover 57 is in contact with the charge collector (cathode charge collector) 26.

The upper cover 56 is formed from a metal foil such as aluminum or the like, and comprises a plate-like center part 56a which covers the opening in the lower cover 57 and comes in contact with the charge collector (anode charge collector) 16, and a clamp part (end) 56b provided along the edge of this center part 56a which grips and clamps the sheath part 57b of the lower cover from above and below.

More specifically, the insulating gasket 60 is interposed between the clamp part 56b of the upper cover 56 and the sheath part 57b of the lower cover 57, and the clamp part 56b of the upper cover 56 extends outwards along the upper surface of the sheath part 57b of the lower cover 57 in the figure, is bent downwards at the outer end of the sheath part 57b, and extends inwards along the lower surface of the sheath part 57b. With the gasket 60 interposed between this clamp part 56b and the sheath part 57b, the clamp part 56b clamps the sheath part 57b so that the sheath part 57b is gripped from above and below. In this way, the laminate A1 is sealed inside the outer packaging formed by the upper cover 56 and lower cover 57.

The center part 56a of the upper cover 56 is electrically connected to the anode 10 of the laminate A1, so the upper cover 53 functions as the anode of the electrochemical device 1A. The base of the cylindrical part 57a of the lower cover 57 is electrically connected to the cathode 20 of the laminate A1, so the lower cover 57 functions as the cathode of the electrochemical device 1A. The gasket 60 electrically insulates the upper cover 56 from the lower cover 57.

In particular, in this embodiment, the clamp part 56b of the upper cover 56 and the sheath part 57b of the lower cover 57 are stuck together by the gasket 60.

This gasket 60 may be made of a resin which is a metal adhesive. For example, a resin such as acid-modified polypropylene or acid-modified polyethylene is preferred. When a resin which sticks to metal when heated is used as the gasket 60, the clamp part 56b of the upper cover 56 is clamped to the sheath part 57b of the lower cover 57 with the gasket 60 interposed therebetween, and the other cover 56 and lower cover 57 can be easily stuck together by the gasket 60 by heating the gasket 60 from outside. Also, if the gasket 60 is an adhesive such as an epoxy resin, clamping and sticking may be performed simultaneously.

In the aforesaid embodiment, the gasket 60 which manifests adhesive properties with respect to metal upon heating is used, and sticking was performed by heat treatment after clamping, but alternatively, an electrically insulating resin having adhesive properties may for example be coated to the upper and lower surfaces of the sheath part 57b as a gasket, and the upper cover then may be placed on top and clamped.

Since this electrochemical device (electrical double layer capacitor 1A) having the aforesaid construction uses the aforesaid electrode of the invention as the anode 10, cathode 20 and two electrodes 30, chipping and peeling of the active substance-containing layer can be adequately suppressed, and short circuits between the electrodes can be adequately suppressed.

### EXAMPLES

The invention will now be described in more detail based on specific examples and comparative examples, but it should be understood that the invention is not to be construed as being limited in any way thereby.

### Example 1

First, 90 mass parts of activated active carbon (commercial name: RP-20, Kuraray Chemicals Ltd.) and 1 mass part of acetylene black (Electrochemical Industries Ltd., commercial name: Denka Black) were introduced into a planetary mixer and mixed for 15 minutes. The obtained mixture and 9 mass parts of fluoride rubber (Dupont Ltd., commercial name: VITON-GF) as binder were mixed with 150 mass parts of MIBK, and kneaded in the planetary mixer for 45 minutes. The obtained kneaded material was further diluted by adding 150 mass parts of MIBK, and an electrode-forming coating solution prepared by stirring for 60 minutes using the planetary mixer.

The above electrode-forming coating solution was uniformly coated on both surfaces of an aluminum foil (thickness: 20 μm) as charge collector by the extrusion lamination method, MIBK was removed by drying at 160° C. for 1.5 hours, the product was pressed by passing between a pair of rollers having flat lateral surfaces, and an electrode sheet wherein an active substance-containing layer (thickness: 135 μm) was formed on one surface of the charge collector of aluminum foil, was thus manufactured. The pressure of the roller press at this time was a line pressure of 1000 kgf/cm.

The obtained electrode sheet was punched out to 50 mm×50 mm, and using a heat press comprising the mold 101 and 102 of shape similar to those shown in FIG. 6 (taper angle θ of mold 101 =1.1°, width W of edge part =50 μm), heating/pressurizing treatment was performed at a temperature of 190° C. and pressure of 0.49 MPA for 60 seconds to obtain the electrode of Example 1. The maximum film thickness D2 of the center part of the active substance-containing layer of this electrode was 130 μm, the decreased film thickness D1 of the edge part was 10 μm, and the value of (D1/D2) was 0.08.

### Comparative Example 1

After manufacturing the electrode sheet in an manner similar to that of Example 1, this electrode sheet was punched out to 50 mm×50 mm to obtain the electrode of Comparative Example 1.

[Evaluation of chipping and peeling] 100 electrodes according to Example 1 and Comparative Example 1 were respectively manufactured, and the presence or absence of chipping and peeling of the active substance-containing layer was verified by electron micrography. Electrodes wherein horizontal chipping and peeling was observed on the electrode surface with a risk of dropout were deemed faulty, and the defect ratios [%] of Example 1 and Comparative Example 1 were calculated. Table 1 shows the results.

[Apparent density measurement] The apparent density [g/cm²] of the active substance-containing layer in Example 1 and Comparative Example 1 was computed from the mass of the active substance-containing layer per 100 cm², and the thickness. Table 1 shows the results.

TABLE 1

| | Defect ratio | Apparent density |
|---|---|---|
| | [%] | [g/cm²] |
| Example 1 | 5 | 0.70 |
| Comparative | 20 | 0.69 |
| Example 1 | | |

### Example 2

Electrodes obtained in Example 1 for which chipping and peeling in the active substance-containing layer were not observed, were selected, and two electrodes were prepared as an anode and cathode.

Next, a lead part (width 2 mm, length 10 mm) of aluminum foil was disposed on the outer edge of the surface of the charge collector on the side where the active substance-containing layer of this anode and cathode were not formed. The anode and cathode were disposed opposite each other, and a separator (52×52 mm, thickness: 50 mm, Nippon Advanced Paper Industries, commercial name: TF4050) and regenerated cellulose nonwoven fabric was placed therebetween so that the anode, separator and cathode were in contact in this order (non-bonded state) to form a laminate.

Next, the aforesaid laminate was introduced into a case formed of a flexible composite packaging film, and seal parts containing a thermocompressed sealant were heat-sealed. The flexible composite packaging film was a laminate comprising an innermost layer (layer of acid-modified polypropylene) of synthetic resin in contact with an electrolyte, a metal layer of aluminum foil and a layer of polyamide laminated in this order. Two of these composite packaging films were superimposed, and their edges were heat-sealed.

The electrolytic solution (propylene carbonate solution containing 1.2 mol/litre of triethylmethylammonium boronfluoride) was injected, and the electrochemical capacitor (electrical double layer capacitor) of Example 2 was thus obtained.

### Comparative Example 2

Electrodes obtained in Comparative Example 1 for which chipping and peeling in the active substance-containing layer were not observed, were selected and two electrodes were prepared as the anode and cathode.

The electrochemical capacitor (electrical double layer capacitor) of Comparative Example 2 was obtained in an manner similar to that of Example 2, except that this anode and cathode were used.

[Short-circuit rate measurement] 10 of the laminates in the electrochemical capacitors of Example 2 and Comparative Example 2 were respectively manufactured, and the electrical resistance of the laminates prior to impregnation with the electrolytic solution was measured using a tester. At this time, laminates for which the resistance value was equal to or greater than 10MΩ were deemed satisfactory, and other laminates were deemed faulty (short-circuit samples). Based on these results, the short-circuit occurrence rate [%] was calculated by the following relation:
Short-circuit occurrence rate [%]=(number of short-circuited samples/total number of samples)×100

[Volumetric capacity measurement] The electrochemical capacitor of Example 2 and Comparative Example 2 were discharged at a fixed current, the cell discharge capacity was computed from the measurement result, and the volumetric capacity was computed from this discharge capacity and the electrode volume. Table 2 shows the results.

TABLE 2

| | Short-circuit | Volumetric |
|---|---|---|
| | occurrence rate [%] | capacity [F/cm²] |
| Example 2 | 0 | 17.8 |
| Comparative | 10 | 17.6 |
| Example 2 | | |

As is clear from the above results, it was found that in the electrode of Example 1 manufactured by the manufacturing method of the present invention, compared to the electrode of Comparative Example 1 manufactured by the prior art manufacturing method, chipping and peeling of the active substance-containing layer are very much reduced, and the apparent density is improved. Also, it was found that in the electrochemical device (electrical double layer capacitor) of Example 2 using the electrode of Example 1, compared to the electrochemical device (electrical double layer capacitor) of Comparative Example 2 using the electrode of Comparative Example 1, the short-circuit occurrence rate was very much reduced. From this, it was concluded that in the electrode of Example 1, compared to the electrode of Comparative Example 1, chipping and peeling of the active substance-containing layer during manufacture of the electrochemical device can be adequately suppressed. Further, it was found that in the electrode of Example 1, compared to the electrode of Comparative Example 2, the volumetric capacity of the electrode is improved.

As described above, according to the present invention, an electrode manufacturing method wherein chipping and peeling of the active substance-containing layer are adequately prevented, and chipping and peeling of the active substance-containing layer during manufacture of an electrochemical device are adequately suppressed, and an electrode wherein chipping and peeling of the active substance-containing layer during manufacture of an electrochemical device are adequately suppressed, can be provided. Also, according to the invention, a method of manufacturing an electrochemical device wherein chipping and peeling of the active substance-containing layer are adequately suppressed, and short-circuits between electrodes are adequately suppressed, and an electrochemical device wherein short-circuits between electrodes are adequately suppressed, can be provided.

1. An electrode manufacturing method, comprising the steps of:
cutting, wherein an electrode sheet formed by an active substance-containing layer on a charge collector is cut to obtain an electrode element which is part of said electrode sheet; and
heating/pressurizing, wherein heating/pressurizing treatment is given to at least the edge part of the active substance-containing layer in said electrode element.

2. The electrode manufacturing method according to claim 1, wherein, in said heating/pressurizing step, said heating/pressurizing treatment is given to said edge part and the center part surrounded by said edge part of said active substance-containing layer.

3. The electrode manufacturing method according to claim 1, wherein, in said heating/pressurizing step, said heating/pressurizing treatment is performed so that the minimum film thickness of the edge part is less than the maximum film thickness of the center part of said active substance-containing layer.

4. The electrode manufacturing method according to claim 3, wherein, in said heating/pressurizing step, said heating/pressurizing treatment is performed so that, if the decreased film thickness of the edge part of said active substance-containing layer is D1 and the maximum film thickness of the center part is D2, the value of (D1/D2) satisfies the following relation:
0.01≦(D1/D2)≦0.4

5. The electrode manufacturing method according to claim 3, wherein, in said heating/pressurizing step, the shape of the edge part of said active substance-containing layer is tapered toward the outside of said center part.

6. The electrode manufacturing method according to claim 1, wherein, in said heating/pressurizing step, the solvent content of said active substance-containing layer is 20 mass % or less.

7. The electrode manufacturing method according to claim 1, wherein said heating/pressurizing treatment is performed at a temperature of 100-250° C.

8. The electrode manufacturing method according to claim 1, wherein said heating/pressurizing treatment is performed at a pressure of 0.098 MPa or more.

9. The electrode manufacturing method according to claim 1, wherein said heating/pressurizing treatment is performed using a heat press.

10. An electrode comprising a charge collector and an active substance-containing layer formed on this charge collector, wherein:
said active substance-containing layer has a center part and an edge part surrounding the center part, at least said edge part being given heating/pressurizing treatment, and
the minimum film thickness of the edge part of said active substance-containing layer is less than the maximum film thickness of the center part.

11. The electrode according to claim 10, wherein, in said active substance-containing layer, the center part and the edge part of said active substance-containing layer are given heating/pressurizing treatment.

12. The electrode according to claim 10, wherein, if the decreased film thickness of the edge part of said active substance-containing layer is D1 and the maximum film thickness of the center part is D2, the value of (D1/D2) satisfies the following relation:
0.01≦(D1/D2)≦0.4.

13. The electrode according to claim 10, wherein the shape of the edge part of said active substance-containing layer is tapered toward the outside of the center part.

14. A method of manufacturing an electrochemical device, said device comprising a first electrode and second electrode arranged facing each other, a separator disposed between said first electrode and said second electrode, an electrolyte disposed between said first electrode and said second electrode, and a case housing said first electrode, second electrode, said separator and said electrolyte sealed inside, wherein:
said electrochemical device manufacturing method comprises a step wherein at least one of said first electrode and said second electrode is manufactured by the electrode manufacturing method according to claim 1.

15. An electrochemical device, comprising:
a first electrode and second electrode arranged facing each other,
a separator disposed between said first electrode and said second electrode;
an electrolyte disposed between said first electrode and said second electrode; and
a case housing said first electrode, second electrode, said separator and said electrolyte sealed inside, wherein:
at least one of said first electrode and said second electrode is the electrode according to claim 10.
